(19) United States
(12) Patent Application Publication
(10) Pub. No.: US 2020/0011107 A1
(43) Pub. Date: Jan. 9, 2020

(54) SYSTEM FOR COVERING A LUGGAGE COMPARTMENT OF A MOTOR VEHICLE

(71) Applicant: TREVES PRODUCTS, SERVICES & INNOVATION, Paris (FR)

(72) Inventors: Alicia LECOMTE, Reims (FR); Nicolas GUENAMANT, Reims (FR); Franck BIEVEN, Reims (FR); Xavier BONFILS, Reims (FR)

(21) Appl. No.: 16/490,791

(22) PCT Filed: Mar. 6, 2018
(86) PCT No.: PCT/FR2018/050519

§ 371 Date: Sep. 3, 2019

(30) Foreign Application Priority Data
Mar. 6, 2017 (FR) 1751799

(51) Int. Cl. E05D 15/06; B60R 5/04; E05D 15/10; E05F 15/646

(52) U.S. Cl. CPC E05D 15/0621; B60R 5/045; E05D 15/10; E05Y 2900/54; E05F 15/646; E05Y 2201/654; E05D 15/0608

(57) ABSTRACT

The invention relates to a system for covering a luggage compartment having two lateral supports each provided with a guide rail, a stationary panel with a horizontal upper face, a flap mounted to slide on the rails and be movable relative to the supports, the flap comprising a second upper face. The flap is movable between covering the compartment and a position for accessing the compartment in which the flap is moved to allow free access to the compartment. The flap being mounted so that the second face keeps its attitude during the transition from one position to the other. The flap in access position is raised and moved forward to cover the panel.

### CROSS-REFERENCE TO RELATED APPLICATIONS

This application claims the benefit of International application number PCT/FR2018/050519, filed Mar. 6, 2018 and French application number 1751799, filed Mar. 6, 2017 the entire contents of which are incorporated herein by reference.

### TECHNICAL FIELD

The invention relates to a system for covering a luggage compartment of a motor vehicle.

### BACKGROUND

Implementing a system for covering a luggage compartment of a motor vehicle is known, said system comprising:

two lateral supports, said supports each being provided with a guide rail,

a stationary panel covering the front part of said compartment, said panel comprising a first substantially planar and horizontal upper face,

a flap mounted so as to slide on said rails so as to be movable relative to said supports, said flap comprising a second substantially planar upper face, said flap being movable between:

a position for covering said compartment in which it is arranged behind said panel, said faces lying substantially in the same plane,

and a position for accessing the compartment in which the flap is moved so as to allow free access to the compartment.

It is in particular known that the flap in the access position folds by a half-turn on the panel, so that their visible faces are arranged one on the other.

With such an arrangement, the folding of the flap must be preceded by the release of the two visible faces of any object that might be situated thereon, which is not very ergonomic.

### SUMMARY OF THE INVENTION

The aim of the invention is to overcome this drawback.

To this end, the invention proposes a system for covering a luggage compartment of a motor vehicle, the system comprising:

two lateral supports, the supports each being provided with a guide rail,

a stationary panel covering the front part of the compartment, the panel comprising a first substantially planar and horizontal upper face,

a flap mounted so as to slide on the rails so as to be movable relative to the supports, the flap comprising a second substantially planar upper face, the flap being movable between:

a position for covering the compartment in which it is arranged behind the panel, the faces lying substantially in the same plane,

and a position for accessing the compartment in which the flap is moved so as to allow free access to the compartment,

the system further having the following features:

the flap is mounted so that the second face keeps its attitude during the transition from one position to the other,

the flap in the access position is raised and moved forward so as to cover the panel.

When it is stated that the second face keeps its attitude during the transition from one position to another, it must be understood that the first and second faces substantially keep their parallelism during the manipulation of the flap from one of its positions to the other.

In this description, the terms for positioning in space (longitudinal, transverse, lateral, front, rear, horizontal, vertical, upper, lower, etc.) are taken with reference to the system in place in the vehicle.

With such an arrangement, the transition of the flap from its covering position to its access position can take place even if objects are placed on the flap, since the second face keeps its attitude during the transition from one of its positions to the other.

The only manipulation to be made is optionally to clear the panel of any objects that might be placed thereon, in order not to interfere with the putting of the flap into the access position.

### BRIEF DESCRIPTION OF THE DRAWINGS

Other particularities and advantages of the invention will emerge in the following description, given with reference to the accompanying figures, in which:

FIGS. 1a and 1b are schematic views in partial perspective of a manual actuation system according to a first embodiment, the flap being arranged in the access position (FIG. 1a) and the covering position (FIG. 1b),

FIG. 2 is a detail enlargement of FIG. 1a carried out at a bifurcation,

FIG. 3 is a view in vertical cross section made at the bifurcation when a rear finger passes vertically in line with it,

FIG. 4 is a schematic perspective view of a motorised actuation system, according to a second embodiment, the flap being arranged in the covering position,

FIG. 5 is a partial schematic lateral view of a first embodiment of a motorised system,

FIG. 6 is a partial schematic lateral view of a second embodiment of a motorised system,

FIG. 7 is a partial schematic lateral view of a third embodiment of a motorised system.

### DETAILED DESCRIPTION

With reference to the figures, a system 1 for covering a luggage compartment of a motor vehicle is described, the system comprising:

two lateral supports 2, the supports each being provided with a guide rail 3,

a stationary panel 5 covering the front part of the compartment, the panel comprising a first substantially planar and horizontal upper face 6,

a flap 7 mounted so as to slide on the rails so as to be movable relative to the supports, the flap comprising a second substantially planar upper face, the flap being movable between:

a position for covering the compartment in which it is arranged behind the panel, the faces lying substantially in the same plane,

and a position for accessing the compartment in which the flap is moved so as to allow free access to the compartment,

the system further having the following features:

the flap is mounted so that the second face keeps its attitude during the transition from one position to the other,

the flap in the access position is raised and moved forward so as to cover the panel.

According to the embodiments depicted:

the flap 7 is provided, on each of the lateral edges thereof, with a front support means 20 projecting laterally from the front end of the edge and with a rear support means 21 projecting laterally from the rear end of the edge, the means sliding on the corresponding rail 3,

the rail extends longitudinally and has:

a downwardly curved rear end part 23, the part being intended to receive the rear means when the flap is in the covering position,

and a middle bifurcation 24, with a form similar to that of the end part in lateral view, the bifurcation being intended to receive the front means when the flap is in the covering position.

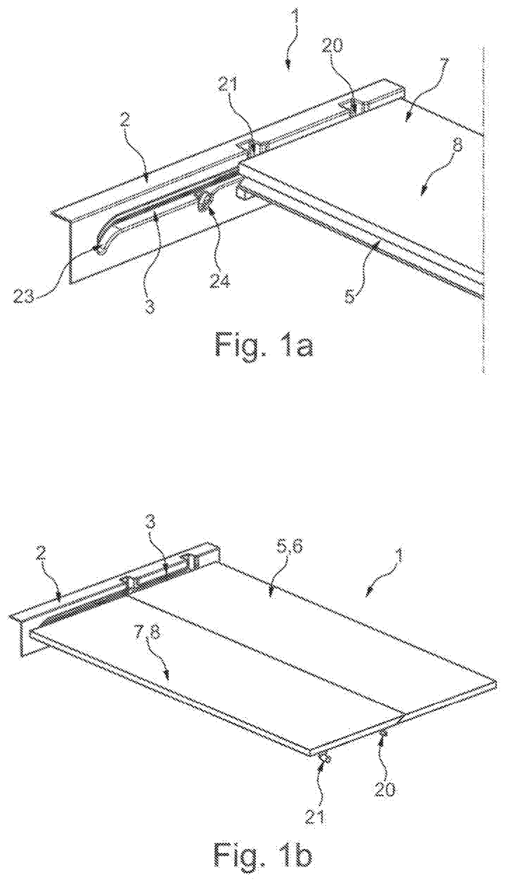

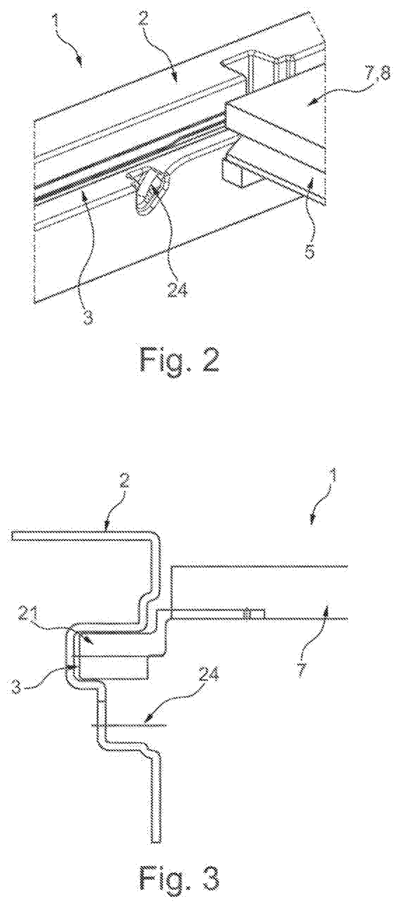

According to the first embodiment, depicted in FIGS. 1 to 3, the support means 20, 21 are in the form of transverse fingers, so as to allow manual actuation of the flap 7 from one of its positions to the other, a rail 3 being conformed as a trench for receiving the sliding fingers.

In particular, as illustrated in FIG. 3, the rear finger 21 projects in an accentuated fashion with respect to the front finger 20, the bifurcation 24 having a depth making it possible to receive the front finger while preventing reception of the rear finger.

Such an arrangement makes it possible, when the flap 7 passes from its access position to its covering position, for the rear finger 21 to be guided towards the rear end part 23 without risk of being engaged in the bifurcation 24, the bifurcation on the other hand being able to receive the front finger 20.

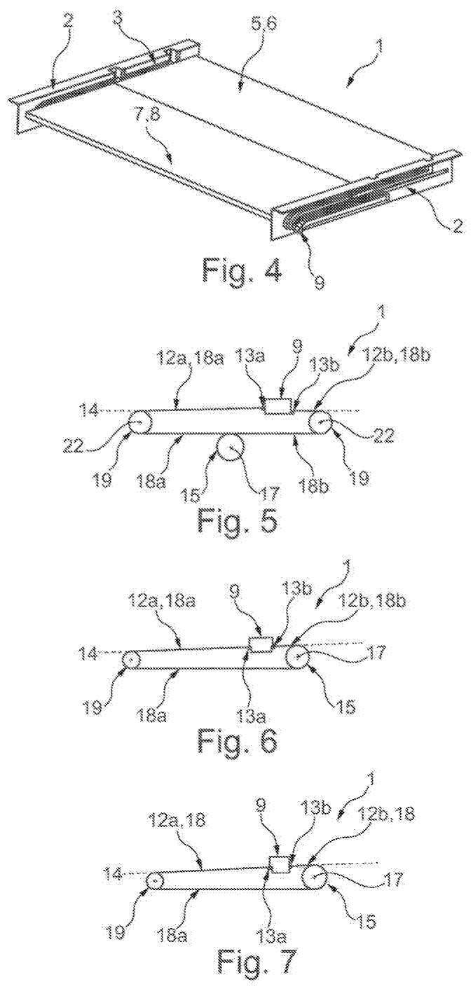

According to the second embodiment, depicted in FIGS. 4 to 7, the rear support means 21, or front support means 20 in a variant that is not shown, are mounted by means of a carriage 9 sliding on the corresponding rail 3, the support means being in particular in the form of fingers fitting in the carriage, the carriage being actuatable by a respective motor, not shown, mounted on the corresponding support 2, so as to allow motorised movement of the flap 7.

According to the embodiments of a motorised system shown in FIGS. 5 to 7, the system 1 has laterally on either side the following features:

a carriage 9 is mounted between a first 12a and second 12b cable portion each having an end 13a, 13b associated respectively on either side of the carriage, the portions being kept under permanent tension on a longitudinal axis 14, at least one of the portions being suitable for elastic deformation so as to allow a movement of the carriage downwards when the flap 7 is put in the covering position,

a wheel 15 actuated by a motor, not shown, is secured to the portions so as to allow actuation, under longitudinal traction, of one or other of the portions as required, in order to move the carriage forwards or backwards in order to bring the flap into the access or covering position.

According to the embodiments in FIGS. 5 and 6, a wheel 15 comprises two grooves, not shown, arranged axially with respect to its transverse rotation axis 17, each of the grooves receiving, so as to be wound, a respective first 18a and second 18b cable defining respectively the first 12a and second 12b cable portions, the cables being wound in two opposite directions in the grooves so that rotating the wheel effects a winding of one and a corresponding unwinding of the other.

It is stated here that, throughout this description, when it is stated that rotating the wheel 15 effects a winding of a cable 18a, 18b and a corresponding unwinding of the other cable 18b, 18a, this means that the wound length of one is equal to the unwound length of the other.

According to the embodiment in FIG. 5:

a support 2 is provided with two pulleys 19 mounted at respective ends of travel of the carriage 9, the pulleys being mounted so as to rotate on two respective transverse axes 22,

a wheel 15 is disposed substantially between the pulleys, each of the pulleys forming a return for each of the cables 18a, 18b so as to keep the portions 12a, 12b under permanent tension.

According to the embodiment in FIG. 6, the system 1 comprises a pulley 19 mounted on the support 2 at an end of travel of the carriage 9, the wheel 15 being disposed at the other end of the travel, the pulley forming a return for one of the cables 18a so as to keep the portions 12a, 12b under permanent tension.

According to the embodiment in FIG. 7, the wheel 15 comprises a groove, not shown, for receiving a cable 18, the end parts of the cable defining the first 12a and second 12b cable portions, the system further comprising a pulley 19 mounted on the support 2 at an end of travel of the carriage 9, the wheel being disposed at the other end of the travel, so that the cable forms a tensioned loop passing around the wheel and the pulley so as to keep the portions under permanent tension.

This is here a friction system, the cable 18 being driven by the wheel 15 by friction, rather than by winding as it is the case in the embodiments described previously.

According to an embodiment applicable to all previously described motorised embodiments, the system 1 further comprises a device, in particular electronic, for synchronising the triggering of the motors, so as to allow optimum actuation of the flap 7 from one of its positions to the other.

What is claimed is:

1. A system for covering a luggage compartment of a motor vehicle, the system comprising:
two lateral supports, the supports each being provided with a guide rail,
a stationary panel covering the front part of the compartment, the panel comprising a first substantially planar and horizontal upper face,
a flap mounted to slide on the rails to be movable relative to the supports, the flap comprising a second substantially planar upper face, the flap being movable between:
a position for covering the compartment in which it is arranged behind the panel, the faces lying substantially in the same plane,
and a position for accessing the compartment in which the flap is moved to allow free access to the compartment,
the system wherein:
the flap is mounted permitting the second face to keep its attitude during the transition from one position to the other,
the flap in the access position is raised and moved forward to cover the panel.

2. The system according to claim 1 wherein:
the flap is provided, on each of the lateral edges, with a front support projecting laterally from the front end of the edge and with a rear support projecting laterally from the rear end of the edge, the support sliding on the corresponding rail
the rail extends longitudinally and has:
a downwardly curved rear end part, the part being intended to receive the rear support when the flap is in the covering position,
and a middle bifurcation, with a form similar to that of the end part in lateral view, the bifurcation being intended to receive the front support when the flap is in the covering position.

3. The system according to claim 2, wherein the supports are in the form of transverse fingers, to allow manual actuation of the flap from one of its positions to the other, a rail being formed as a trench for receiving the sliding fingers.

4. The system according to claim 3, wherein the rear finger projects in an accentuated fashion with respect to the front finger, the bifurcation having a depth making it possible to receive the front finger while preventing reception of the rear finger.

5. The system according to claim 2, wherein the rear support or front support are mounted by a carriage sliding on the corresponding rail, the carriage being actuatable by a respective motor mounted on the corresponding support, to allow motorised movement of the flap.

6. The system according to claim 5, wherein it has laterally on either side the following features:
a carriage is mounted between a first and second cable portion each having an end associated respectively on either side of the carriage, the portions being kept under permanent tension on a longitudinal axis, at least one of the portions being suitable for elastic deformation to allow a movement of the carriage downwards when the flap is put in the covering position,
a wheel actuated by a motor is secured to the portions to allow actuation, under longitudinal traction, of one or other of the portions as required, in order to move the carriage forwards or backwards in order to bring the flap into the access or covering position.

7. The system according to claim 6, wherein a wheel comprises two grooves arranged axially with respect to its transverse rotation axis, each of the grooves receiving, to be wound, a respective first and second cable defining respectively the first and second cable portions, the cables being wound in two opposite directions in the grooves so that rotating the wheel effects a winding of one and a corresponding unwinding of the other.

8. The system according to claim 7, wherein:
a support is provided with two pulleys mounted at respective ends of travel of the carriage, the pulleys being mounted to rotate on two respective transverse axes,
a wheel is disposed substantially between the pulleys, each of the pulleys forming a return for each of the cables to keep the cable portions under permanent tension.

9. The system according to claim 7, wherein it comprises a pulley mounted on the support at an end of travel of the carriage, the wheel being disposed at the other end of the travel, the pulley forming a return for one of the cables to keep the portions under permanent tension.

10. The system according to claim 6, wherein the wheel comprises a groove for receiving a cable, the end parts of the cable defining the first and second cable portions, the system further comprising a pulley mounted on the support at an end of travel of the carriage, the wheel being disposed at the other end of the travel, so that the cable forms a tensioned loop passing around the wheel and the pulley to keep the portions under permanent tension.
